(19) United States
(12) Patent Application Publication
(10) Pub. No.: US 2012/0161627 A1
(43) Pub. Date: Jun. 28, 2012

(54) LED ILLUMINATING DEVICE

(75) Inventors: SHAO-HAN CHANG, Tu-Cheng (TW); QING-SHAN CAO, Shenzhen City (CN); XIAO-MAN PU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/191,475

(22) Filed: Jul. 27, 2011

(30) Foreign Application Priority Data
Dec. 25, 2010 (CN) 201010605401.1

(51) Int. Cl. H01J 13/46

(52) U.S. Cl. 315/35

(57) ABSTRACT

An LED illuminating device includes a housing including a first open end and a second open end, and a base including an upper base fixed on the first open end and a bottom base held inside the housing. An LED substrate is mounted on the upper base and includes a number of LEDs. A number of first vents are defined in the upper base, and a number of second vents are defined on the second open end of the housing. A space is formed between the lateral wall of the bottom base and the inside wall of the housing, and communicates with the first vents and the second vents.

### BACKGROUND

1. Technical Field

The present disclosure relates to light emitting diode (LED) illuminating devices and, particularly, to an LED illuminating device with heat dissipation module.

2. Description of Related Art

Compared to traditional light sources, LEDs have many advantages, such as high luminous efficiency, low power consumption, and long service life. To dissipate heat from LED lamps, a type of heat sink called “sunflower heat sink” is often used in LED lamps having a plurality of LEDs. The sunflower heat sink has a post-shaped conductive member and a plurality of fins extending outwardly and radially from a circumferential surface of the conductive member. One problem with this type of LED illuminating devices is its large size and heavy weight. In addition, dust tends to cumulate in the spaces between the fins, which will affect heat dissipation.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of an LED illuminating device in accordance with an exemplary embodiment.

FIG. 2 is an isometric, exploded view of the LED illuminating device of FIG. 1.

FIG. 3 is a schematic view of a base of the LED illuminating device of FIG. 1.

FIG. 4 is a schematic view of a housing of the LED illuminating device of FIG. 1.

FIG. 5 is a schematic, cross-sectional view showing a heat dissipation pattern of the LED illuminating device of FIG. 1.

### DETAILED DESCRIPTION

Embodiments of the present disclosure are now described in detail, with reference to the accompanying drawings.

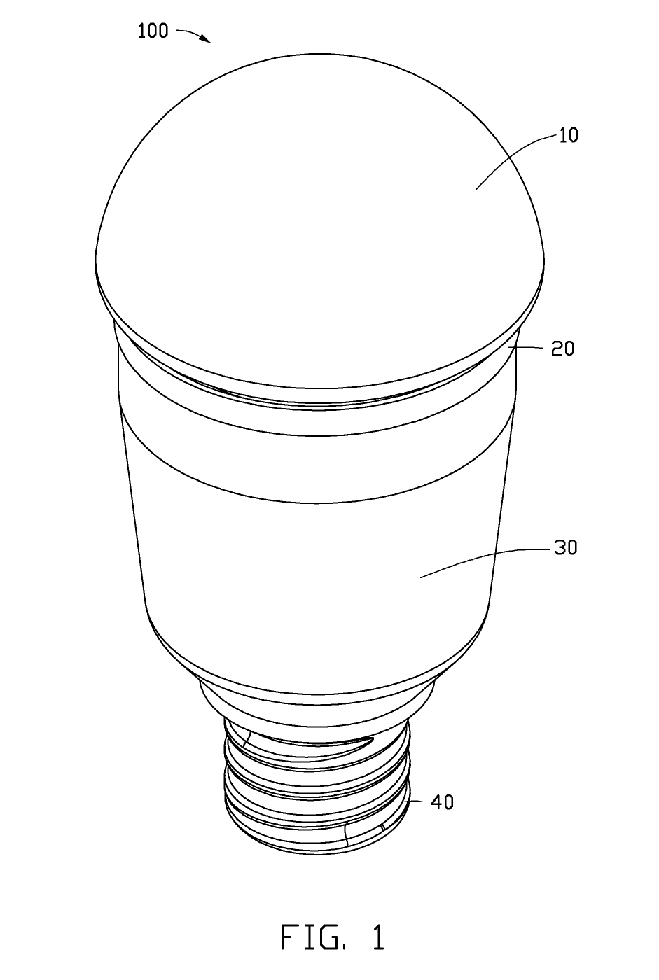

Referring to FIG. 1, an embodiment of an LED illuminating device 100 is illustrated. The device 100 includes a bulb 10, a base 20, a housing 30, and a connector 40. The bulb 10 is fixed on the base 20. The base 20 and the connector 40 are respectively attached to two opposite ends of the housing 30. The connector 40 is used to connect to a coupling connector to electrically connect the device 100 to a power source.

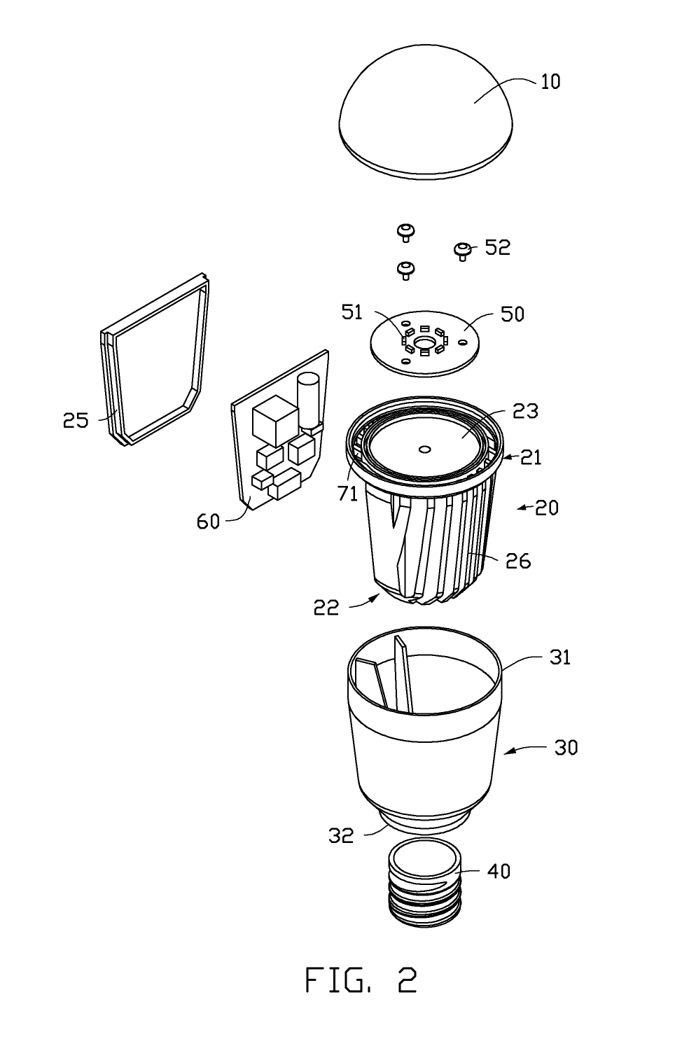

Referring to FIG. 2, the device 100 further includes an LED substrate 50 and a driving circuit 60. A number of LEDs 51 are arranged on the LED substrate 50. The driving circuit 60 is electrically connected to the connector 40 and the LED substrate 50.

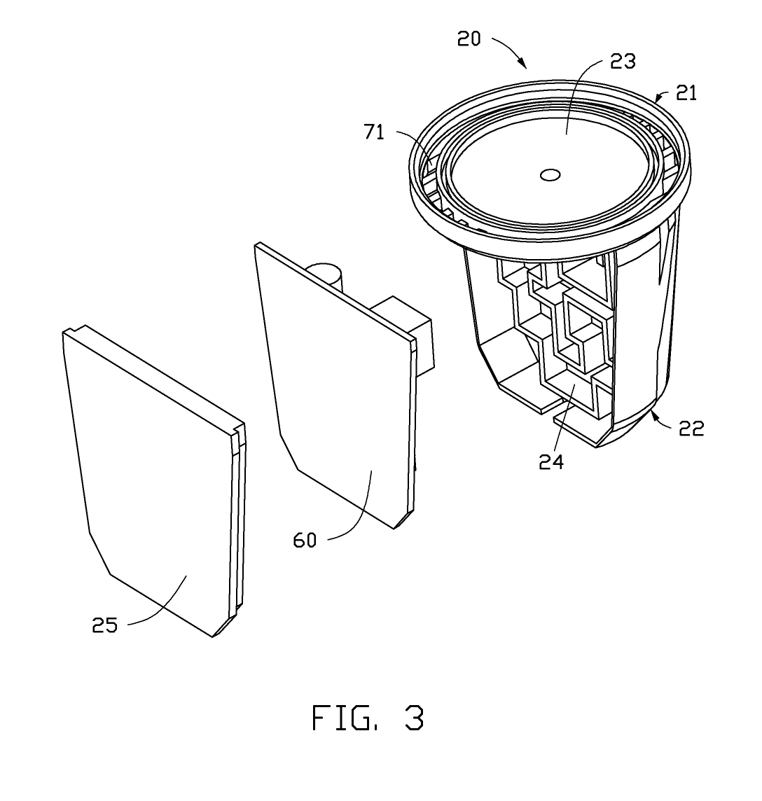

Referring to FIG. 3, the base 20 includes an upper base 21 and a bottom base 22. In this embodiment, the base 20 is made of metal with good heat conductivity, such as copper or aluminum. In another embodiment, the base 20 can be made of ceramic. The upper base 21 is shaped like a flat disc. A recess 23 is formed in the top surface of the upper base 21 for receiving the LED substrate 50. The LED substrate 50 can be fixed in the recess 23 with screws 52. In this embodiment, a heat-conductive medium (not shown) is arranged between the LED substrate 50 and the top surface of the upper base 21 for transferring the heat generated by the LEDs 51 from the LED substrate 50 to the base 20. The heat-conductive medium can be a graphite sheet, heat-conductive glue, or heat-conductive ceramic. A number of first vents 71 are defined on the top surface of the upper base 21.

The bulb 10 is connected to the upper base 21. The bulb 10 can be made of transparent or translucent material mixed with light diffusion particles to improve the light scattering effect of the light. In other embodiments, a scatter layer or a film of scatter material can be arranged on the surface of the bulb 10 to scatter the light beams emitting from the LEDs 51, thus achieving a homogeneous illuminating effect.

A receiving space 24 is defined on the bottom base 22 for receiving the driving circuit 60. In this embodiment, the bottom base 22 further includes a cover 25 for covering the receiving space 24. The cover 25 can be fixed to the receiving space 24 by any suitable connection techniques, such as screwing. The bottom base 22 includes a number of cooling fins 26 arranged on the outer surface of the bottom base 22, thereby enhancing heat dissipation.

A heat-conductive medium (not shown) is set in the receiving space 24 for transferring the heat generated by the driving circuit 60 to the cooling fins 26, thus improving the heat-conductive efficiency of the LED illuminating device 100.

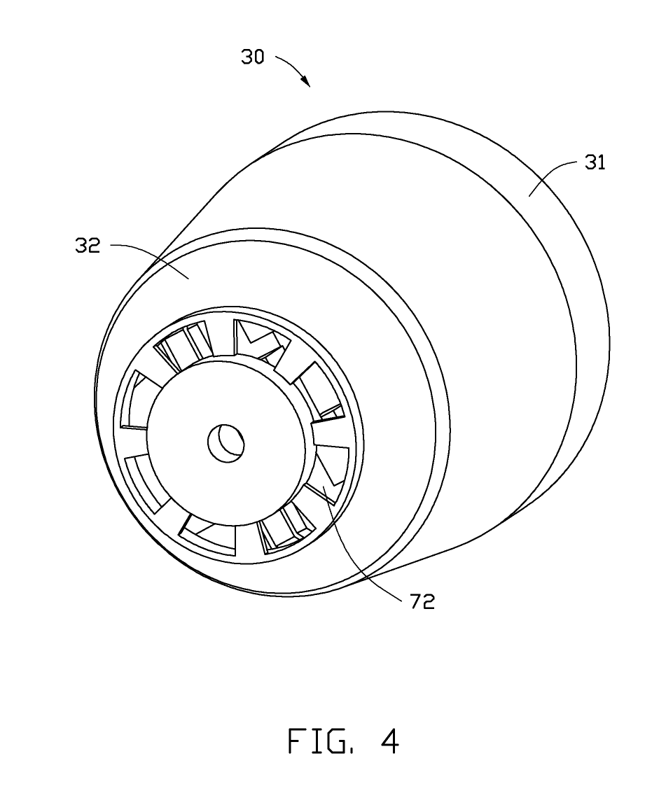

Referring to FIGS. 2 and 4, the housing 30 is made of metal with good heat conductivity, such as copper or aluminum, and is cylindrical. The housing 30 includes a first open end 31 and a second open end 32 opposite to the first open end 31. The upper base 21 is fixed on the first open end 31 of the housing 30, and the bottom base 22 is held inside the housing 30. In this embodiment, the upper base 21 can be connected to the first open end 31 through threaded connection, which can increase the contact area between the upper base 21 and the housing 30 to promote the heat exchange between the base 20 and the housing 30. Furthermore, in the embodiment, a heat-conductive medium can be filled between the upper base 21 and the first open end 31 to reduce the thermal resistance therebetween. The connector 40 is fixed on the second open end 32 of the housing 30. A number of second vents 72 are defined on the second open end 32 of the housing 30, and the second vents 72 communicate with the first vents 71.

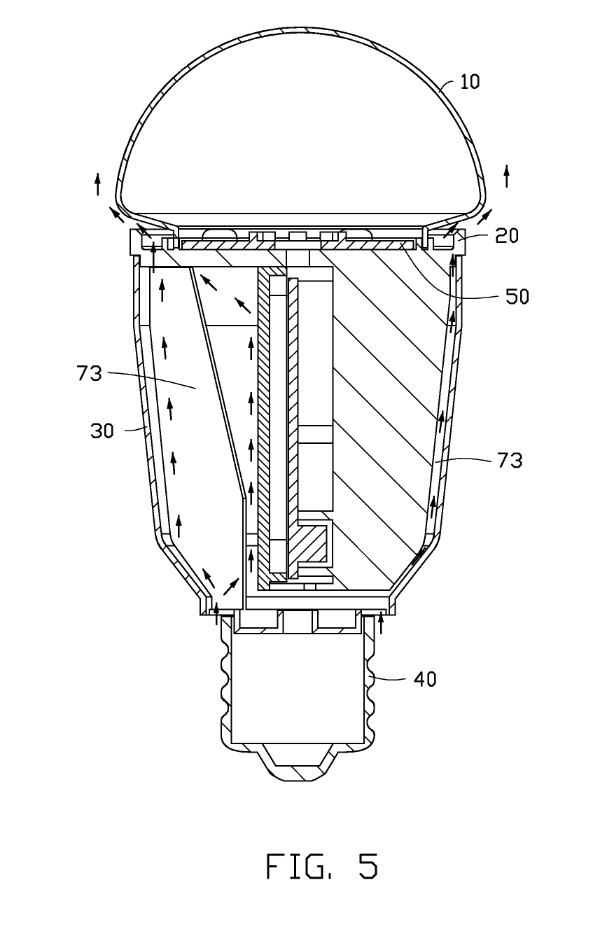

Referring to FIG. 5, the external diameter of the bottom base 22 is less than the internal diameter of the housing 30, to form a space 73 between the lateral wall of the bottom base 22 and the inside wall of the housing 30. The heat generated by the LED substrate 50 is transferred to the housing 30 and the bottom base 22 via the upper base 21, and finally is transferred outside of the housing 30. The space 73 serves as a communication channel to promote heat exchange between hot air in the housing 30 and cool air outside the housing 30. The hot air exits the LED illuminating device 100 from the first vents 71. The cool air enters the space 73 from the second vents 71. The cool air cools the LED illuminating device 100 by heat exchanging with the cooling fins 26 and the inside wall of the housing 30, thus promoting the cooling efficiency.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED illuminating device, comprising:
a housing comprising a first open end and a second open end opposite to the first open end;
a base comprising an upper base fixed on the first open end and a bottom base received within the housing;
a driving circuit accommodated in the bottom base;
an LED substrate mounted on the upper base and comprising a plurality of LEDs; and
a connector fixed on the second open end of the housing and configured to electrically connect the LED illuminating device to a power source;
wherein a plurality of first vents is defined in the upper base and a plurality of second vents is defined on the second open end of the housing, a space is formed between a lateral wall of the bottom base and an inside wall of the housing, and the space communicates with the first vents and the second vents.

2. The LED illuminating device according to claim 1, wherein the base is made of metal or ceramic.

3. The LED illuminating device according to claim 1, wherein a recess is formed in the top surface of the upper base for receiving the LED substrate.

4. The LED illuminating device according to claim 1, wherein a receiving space is formed on the bottom base for receiving the driving circuit.

5. The LED illuminating device according to claim 4, wherein the bottom base further comprises a cover for sealing the driving circuit in the receiving space.

6. The LED illuminating device according to claim 1, wherein a plurality of cooling fins are arranged on an outer surface of the bottom base to enhance a heat dissipation area.

7. The LED illuminating device according to claim 1, the LED illuminating device further comprises a bulb connected to the upper base.

8. The LED illuminating device according to claim 7, wherein the bulb is made of transparent or translucent material mixed with light diffusion particles.
